(19) United States
(12) Patent Application Publication
(10) Pub. No.: US 2010/0138921 A1
(43) Pub. Date: Jun. 3, 2010

(54) Countering Against Distributed Denial-Of-Service (DDOS) Attack Using Content Delivery Network

(75) Inventors: Won-Taek NA, Seoul (KR); Hyeong-Seong BAEG, Seoul (KR); Choon-Hwan BYUN, Seoul (KR); Jeong-Woo LIM, Seoul (KR); Hyo-Soo HAN, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: CDNETWORKS CO., LTD., Seoul (KR)

(21) Appl. No.: 12/623,931

(22) Filed: Nov. 23, 2009

(30) Foreign Application Priority Data
Dec. 2, 2008 (KR) 10-2008-0121365

(51) Int. Cl. G06F 11/00

(52) U.S. Cl. 726/22

(57) ABSTRACT

Method and apparatus for blocking a distributed denial-of-service (DDoS) attack are provided. It is first determined whether a traffic status of an origin server is based on the DDoS attack. When it is determined that the traffic status of the origin server is based on the DDoS attack, a DNS is requested to change an Internet protocol (IP) address of the origin server to the IP address of at least one of plural servers. Accordingly, it is possible to accept a normal service providing request and also to determined and block the DDoS attack. In addition, since a device for determining and blocking the DDoS attack need not be installed in each site or server, it is possible to efficiently determine and block the DDoS attack at reduced cost.

### BACKGROUND

1. Field of Art

The present invention relates to taking measures against distributed denial-of-service (DDoS) attacks, and more particularly, to determining and taking measures against a DDoS attack using networking devices installed in a communication network.

2. Description of Art

Communication networks such as Internet are designed for access by multiple parties to effectively exchange information. Open nature of such communication networks also means that any one can attempt to access any resources available through the communication networks. A distributed denial-of-service (DDoS) attack is a form of an attack that takes advantage of the open nature of the communication network. Specifically, the DDoS attack attempts to make a computing resource (e.g., server) unavailable to its intended users by simultaneously concentrating data traffic on the computing resource from multiple attack sources. By overpowering the computing resource with a deluge of data traffic, the computing resource becomes incapable of servicing to its intended users.

One of the issues in preventing the DDoS attack lies in the difficulty associated with distinguishing increased service requests from the intended users from increased data traffic caused by a DDoS attack. If service requests are blocked unconditionally whenever a sudden deluge of data traffic is detected, even increased data traffic caused by the intended users may result in the blocking of all data traffic. To avoid blocking increased traffic from the intended users, various schemes for determining and blocking the DDoS attack have been studied and proposed.

One conventional method of determining presence of the DDoS attack involves the use of devices at the nodes of the network. In this method, the DDoS attack is determined by inspecting a part of or entire traffic in a network switch or circuit for any abnormality. When the DDoS attack is determined using the devices (e.g., an L7 switch) at the nodes of the network, the contents of the packet can be analyzed.

Another conventional method of determining the DDoS attack adopts a network behavior analysis. This method involves collecting and analyzing information created by network switches to determine presence of any abnormality in the traffic. This method advantageously reduces the cost and also effectively copes against modified DDoS attacks.

Yet another conventional method of determining the DDoS attack employs Honeynet. This method involves tracing the mute of Bot Infections of attack sources using Honeynet before the infected Bots initiate a DDoS attack. This method allows identification of the source of the DDoS attack, and hence, allows the DDoS attack to be blocked at the source. Further, the nature and the method of the DDoS attack can be accurately analyzed.

Once a DDoS attack is identified, measures are taken to block the attack. The DDoS attack can be blocked, for example, by blocking a node in the network, blocking an entire path associated with an Internet Service Provider (ISP) or blocking a range of nodes of an Internet Data Center (IDC).

### SUMMARY

Embodiments relate to blocking a DDoS attack on an origin server in a network system by an attack determining device. The network system including a domain name system (DNS), the attack determining device, a plurality of replicating servers, and the origin server. The attack determining device monitors traffic of the origin server and determines whether the traffic of the origin server is associated with the DDoS attack. The attack determining device requests the DNS to change mapping of Internet protocol (IP) addresses and domain names so that service requests to the origin server are sent to at least one of the plurality of replicating servers responsive to detecting that the monitored traffic is associated with the DDoS attack on the origin server.

In one embodiment, the traffic of the origin server determines whether an amount of traffic for the origin server exceeds a predetermined value. Then it is determined whether the traffic of the origin server is associated with the DDoS attack responsive to the amount of traffic of the origin server exceeding the predetermined value.

In one embodiment, the DNS changes the mapping of a domain name associated with the origin server to the IP address of at least one of the plurality of replicating servers before determining whether the traffic of the origin server is associated with the DDoS attack responsive to the amount of traffic of the origin server exceeding the predetermined value.

In one embodiment, the DNS is requested to revert the mapping of the domain name of the origin server to the IP address of the origin server from the IP address of at least one of the plurality of replicating servers responsive to determining that the traffic of the origin server is not associated with the DDoS attack.

In one embodiment, service requests to the origin server are blocked responsive to determining that the traffic of the origin server is associated with the DDoS attack.

In one embodiment, the network system further includes a load balancer (LB). The DNS is requested to change the IP address of the origin server to the IP address of at least one of the plurality of replicating servers by providing the IP address to be changed to the LB. The LB determines load conditions of the replicating servers and selects an optimal replicating server to respond to service requests to the origin server.

In one embodiment, the at least one of the plurality of replicating servers requests the origin server to provide contents responsive to determining that the traffic of the origin server is associated with the DDoS attack. Further, the DNS is requested to change the mapping of the domain name of the origin server to the IP address of at least one of the plurality of replicating servers.

### BRIEF DESCRIPTION OF THE DRAWINGS

FIG. 1 is an architectural diagram illustrating the configuration of a network system for blocking a DDoS attack, according to one embodiment.

FIG. 2 is a flowchart illustrating a method of blocking a DDoS attack, according to one embodiment.

FIG. 3 is a block diagram illustrating an attack determining device according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

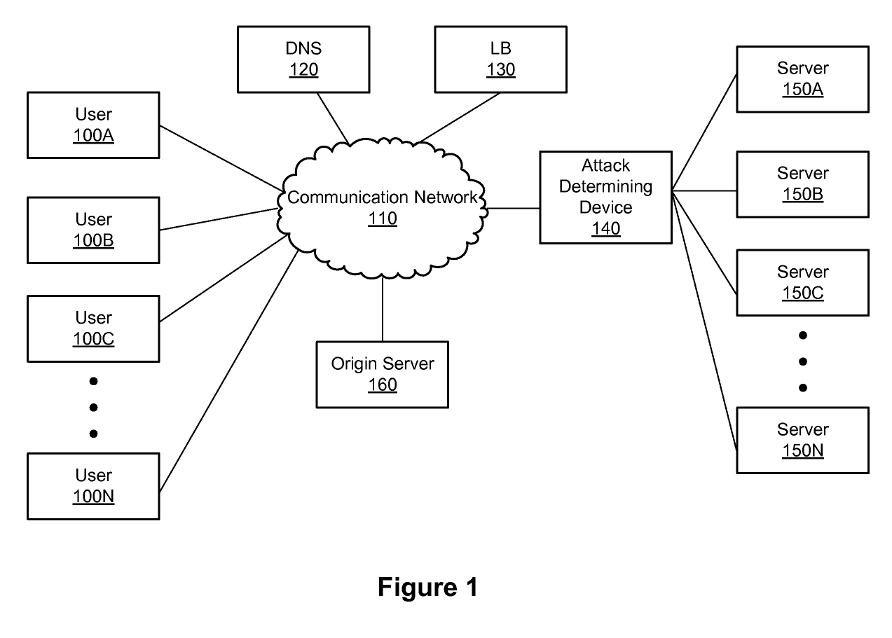

FIG. 1 is a diagram illustrating the configuration of a network system implementing a method of blocking a DDoS attack, according to one embodiment. The network system may include, among other components, a plurality of users 100a through 100n (collectively referred to as the “users 100” herein), a Domain Name System (DNS) 120, a Load Balancer (LB) 130, an attack determining device 140, a plurality of replicating servers 150a through 150n (collectively referred to as the “replicating servers 150” herein), and an origin server 160. These components communicate with each other via a communication network 110.

The communication network 110 may include multiple processing systems. The communication network 110 may include a local area network (LAN), a wide area network (WAN) (e.g., the Internet), and/or any other interconnected data path across which multiple devices may communicate. Data in the communication network 110 may be distributed using standard network protocols such as TCP/IP, HTTP, HTTPS, and SMTP. The type and topology of the communication network 110 are not limited, and various communication network 110 may used.

The users 100 make requests for services to receive, for example, web pages or other content items to the origin server 160 via the communication network 110. In return, the origin server 160 sends the requested web pages or other content items to the users 100 via the communication network 110. In one embodiment, the users 100 represent computing devices used by human users to request data such as web pages or other content items from the origin server 160. The users 100 may include, among others, personal computers, Personal Digital Assistants (PDAs) and mobile phones. The users 100 can access the communication network 110 via various Internet Service Providers (ISPs).

The DNS 120 is a name service system for translating a domain name into Internet Protocol (IP) addresses consisting of numbers. The DNS 120 may include at least one name server that stores a reference table or a database for mapping domain names to IP addresses. A plurality of name servers can be hierarchically structured as a local DNS and a parent DNS. When the DNS includes a plurality of name servers in a hierarchical structure, a networking device may be provided. The networking device selects a name server to provide a name service the plurality of name servers to serve requests from multiple DNSs 120. The translating of the domain names to the IP addresses can be performed by communicating between the devices in the DNS 120. After receiving a request including a destination domain name from a user's computing device (e.g., by a user's manual input), the DNS 120 matches the domain name against an IP address of a server (e.g., the origin server 160) and returns the IP address to the user's computing device. The user's computing device then makes a request to the server with its IP address mapped to the destination domain name.

A so-called Contents Delivery Network (CDN) service distributes computing load associated with servicing requests to the origin server 160 by caching the contents in the origin server 160 to other replicating servers 150 and selecting an optimal server to service a user 100 based on the status of the replicating servers 150. For this purpose, the LB 130 communicates with the replicating servers 150 to receive status information from the replicating servers 150. Based on the status information, the LB 130 determines the optimal server and provides information on the selected optimal server to the DNS 120. In one embodiment, the replicating server selected as the optimal server has the lowest load among the replicating servers 150. After receiving the information about the selected optimal server, the DNS 120 may assign the replicating server with the lowest load to service the contents to the users 100.

The LB 130 may also communicate with the origin server 160 to determine the status of the origin server 160. Based on the status information of the origin server 160 and the replicating servers 150, the LB 130 may select an optimal server among the origin server 160 and the replicating servers 150. It is advantageous to include the origin server 160 as a candidate server of the optimal server because the contents may be provided from the origin server 160 if the contents are not stored or available from the replicating servers 150.

The attack determining device 140 monitors the origin server 160, determines the presence of the DDoS attack on the origin server 160, and takes measures to block the attack. The attack determining device 140 is connected to the replicating servers 150 and other components of the network system such as the users 100, the DNS 120, the LB 130, and the origin server 160. Although the replicating servers 150 in FIG. 1 are illustrated as being connected to the communication network 110 via the attack determining device 140, the replicating servers 150 may also be connected directly to the communication network 110. In one embodiment, the replicating servers 150 do not store or serve contents of the origin server 160 to the users 100 before suspicious data traffic is detected. That is, the replicating servers 150 cache and serve content items of the origin server 160 after data traffic suspicious of a DDoS attack is detected.

In one embodiment, after detecting suspicious data traffic that may be associated with a DDoS attack on the origin server 160, the attack determining device 140 requests the DNS 120 to temporarily change mapping of the domain name of the origin server 160 from the IP address of the origin server 160 to the IP addresses of the replicating servers 150. That is, entries in the reference table or the database of the DNS 120 is modified so that the domain name of the origin server 160 is related with the IP addresses of the replicating servers 150 instead of the IP address of the origin server 160. In this way, the origin server 160 is relieved of servicing the users 100 by changing the mapping of the domain name and the IP address in the DNS 120. Based on the changed mapping, the DNS 120 returns the IP address of one of the replicating servers 150 in response to receiving the request for the IP address of the origin server 160.

In another embodiment, the request to change the mapping of the domain name is made to the LB 130 instead of the DNS 120. After receiving the request, the LB 130 does not select the origin server 160 to service requests to the original server 160. In this way, the origin server 160 is removed from the candidate server of the optimal server for responding to the service requests.

While the replicating servers 150 are temporarily responding to the service requests from the users 100 instead of the origin server 160, the attack determining device 140 makes further determination whether the data traffic is indeed caused by a DDoS attack. When the attack determining device 140 determines that the traffic is indeed caused by a DDoS attack on the origin server 160, the content items from the origin server 160 may be copied to the replicating servers 150 to respond to the service requests from the intended users 100 and also take measures to block the DDoS attack. If the contents are already stored in the replicating servers 150, then the copying of the contents form the origin server 160 may be obviated.

Embodiments described above are advantageous for various reasons. First, it is possible to block the DDoS attack using the components already installed and operating in a contents delivery network. That is, no separate mechanism needs to be deployed at the web sites providing the contents. As a result, it is possible to determine and block the DDoS attack without hindering the origin server 160 from providing the contents.

In one embodiment, the LB 130, the attack determining device 140, and the replicating servers 150 are operated and managed by a CDN service provider.

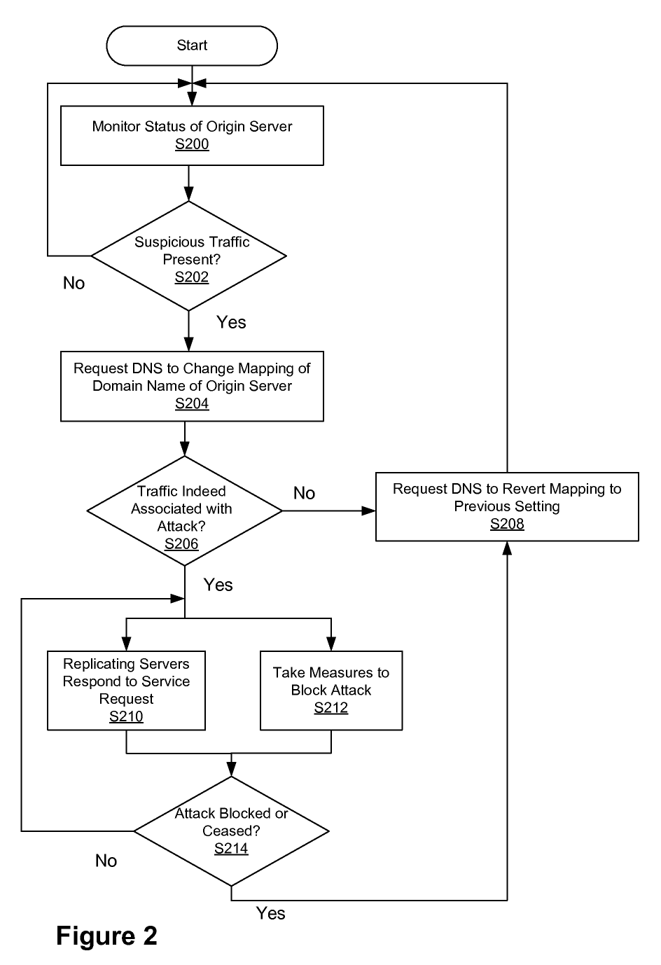

FIG. 2 is a flowchart illustrating a method of blocking a DDoS attack, according to an embodiment. First, the status of the origin server 160 is monitored S200 by the attack determining device 140 for data traffic associated with a DDoS attack. The attack determining device 140 determines S202 if the data traffic of the origin server 160 is suspected as part of a DDoS attack.

It is difficult to determine if the origin server 160 is being a subject of a DDoS attack or experiencing increased data traffic from intended users. Hence, criteria such as abnormal increase in traffic may be used to flag the possibility that the origin server 160 is being subject to a DDoS attack. When the criteria is satisfied, the attack determining device 140 requests the DNS 120 to change the IP address associated with a domain name corresponding to the origin server 160 to the IP addresses of the replicating servers 150. In response, the DNS 120 changes S204 the mapping of the domain name of the origin server 106 and the IP addresses. As set forth above with reference to FIG. 1, the mapping may be changed by updating entries in the reference table or the database in the DNS 120. In this way, the replicating servers 150 may respond to the service requests from the intended users 100 even when the data traffic to the origin server 160 is being analyzed to determine if the data traffic is associated with a DDoS attack.

In one embodiment, the origin server 160 also participates in servicing the requests while the data traffic is being analyzed to determine if the data traffic is indeed associated with a DDoS attack. By having the replicating servers 150 respond to service requests while determination is being made as to whether a DDoS attack is being launched against the origin server 160, it is possible to enhance the stability of the origin server 160.

In one embodiment, the replicating servers 150 do not respond to the service requests before determining that the origin server 160 is being subject to the DDoS attack. That is, the replicating servers 150 start responding to the requests only after the data traffic is determined as being associated with the DDoS attack.

The attack determining device 140 determines S206 if the suspected traffic is associated with a DDoS attack. If it is determined that the traffic is not associated with the DDoS attack, the attack determining device 140 requests S208 the DNS 120 to revert the mapping of the domain name to the IP address of the origin server 160. In response, the DNS 120 changes the mapping of the domain name of the origin server 160 to original setting where the domain name of the origin server 160 is mapped to the IP address of the origin server 160. That is, the entries of the reference table or the database of the DNS 120 is reverted back to a previous setting where the domain name of the origin server 160 is associated with the IP address of the origin server 160.

When it is determined that the traffic is associated with a DDoS attack, the replicating servers 150 continue to respond to the service requests from the users 100 instead of the origin server 160. That is, the reference table or the database of the DNS 120 as modified in step S204 is maintained to respond to the service requests from the users 100.

As described above with reference to FIG. 1, the request to the DNS 120 to change the IP addresses of the domain name corresponding to the origin server 160 to the IP addresses of the replicating servers 150 may be performed by the LB 130.

In the process illustrated in FIG. 2, separate step S202 of determining the presence of the suspected traffic and step S204 of requesting the DNS 120 to change the mapping of IP address of the origin server 160 are provided. However, if the attack determining device 140 can instantaneously determine whether the data traffic is associated with the DDoS attack, steps S202 and S204 may be obviated. In most cases, however, it is difficult to distinguish the DDoS attack from the intended users' service requests. Accordingly, criteria such as excessive amount of traffic at a certain time are used to raise the suspicion of a DDoS attack, followed by more detailed analysis on the traffic to determines S206 if the increased traffic is indeed associated with the DDoS attack.

Various methods may be used to determine whether a DDoS attack is being launched against the origin server 160. The DDoS attack can be determined, for example, by using devices at the nodes of the network, by performing the network behavior analysis, or by using Honeynet to determine the DDoS attack. Other methods not described herein may also be used to determine the DDoS attack.

When it is determined that the DDoS attack is being launched against the origin server 160, measures are taken S212 to block the DDoS attack. Various methods of blocking the DDoS attack may be employed. The DDoS attack may be blocked, for example, by blocking a node in the network 110, by blocking entire paths associated with an ISP, or by blocking a series of nodes associated with an IDC. Other methods not listed herein may also be used to block the DDoS attack. In one embodiment, the DDoS attack is blocked by the attack determining device 140 or other devices connected to the attack determining device 140 to receive the information from the attack determining device 140. Details of the method of blocking the DDoS attack is omitted herein so as not to avoid unnecessarily obfuscating the embodiments.

After taking measures to block the DDoS attack, the traffic data is monitored to determine if the DDoS attack is completely blocked or ceased S214. If the DDoS attack is completely blocked or ceased, the DNS 120 is requested to revert S208 the mapping of the domain name to that was originally associated with the origin server 160 back to the IP address of the origin server 160. In response, the DNS 120 changes S208 the mapping of the IP addresses. The mapping can be reverted by returning the entries in the reference table or the database of the DNS 120 to the previous setting.

In one embodiment, the contents delivery network is not used in a normal network status where a DDoS attack is not suspected. When suspected traffic associated with the DDoS attack is detected, the components of the contents delivery network already operating and available may be used to mitigate damages due to the DDoS attack. By using the characteristics of the contents delivery network, it is possible to determine and block the DDoS attack while continuing to provide the contents to intended users.

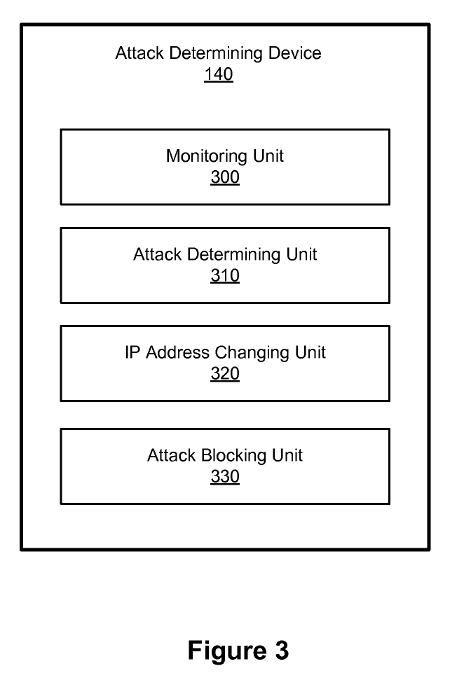

FIG. 3 is a block diagram illustrating an attack determining device 140 according to one embodiment. The attack determining device 140 may include, among other components, a monitoring unit 300, an attack determining unit 310, an IP address changing unit 320, and an attack blocking unit 330. One or more components of the attack determining device 140 may be embodied as hardware, firmware, software or any combination thereof.

One or more of the monitoring unit 300, the attack determining unit 310, the IP address changing unit 320, and the attack blocking unit 330 may be embodied as are embodied as hardware, software, firmware or any combinations thereof. In one embodiment, one or more of the monitoring unit 300, the attack determining unit 310, the IP address changing unit 320, and the attack blocking unit 330 includes electronic instructions stored in a computer-readable recording medium such as a CD ROM, a RAM, a ROM, a floppy disk, a hard disk, and a magneto-optical disk. The instructions may be read by a processor in the attack determining device 140 to perform operations to monitor, determine or take measures against DDoS attacks.

The monitoring unit 300 is hardware, software, firmware or any combinations thereof for monitoring the status of the origin server 160 and detects suspicious traffic that may be associated with a DDoS attack on the origin server 160. In one embodiment, the monitoring unit 300 monitors the number of service requests to the origin server 160. If the number of service requests exceeds a set number for a certain time, the monitoring unit 300 determines that the data traffic is suspicious as part of a DDoS attack.

Although the monitoring unit 300 is illustrated in FIG. 2 as being included in the attack determining device 140, the monitoring unit 300 may be also be included in other servers. Alternatively, the monitoring unit may be provided as a separate device.

The attack determining unit 310 is hardware, software, firmware or any combinations thereof for further analyzing the traffic to determine whether the suspected traffic is indeed associated with the DDoS attack. When the attack determining unit 310 determines that the traffic to the origin server 160 is associated with the DDoS attack, the IP address changing unit 320 requests the DNS 120 to change the IP address associated with the domain name of the origin server 160 to the IP addresses of the replicating servers 150.

In order to enhance the stability of the service provided from the origin server 160, the replicating servers 150 can respond to the service requests instead of the origin server 160 when the attack determining unit 310 determines that the traffic is associated with the DDoS attack.

The attack blocking unit 330 is hardware, software, firmware or any combinations thereof for blocking the DDoS attack on the origin server 120. For example, the attack blocking unit 330 blocks the DDoS attack by blocking the traffic to the origin server 160 when the attack determining unit 310 determines that the traffic to the origin server 160 is associated with the DDoS attack. In one embodiment, the attack blocking unit 330 is constructed as a device separated from the attack determining device 140.

In one embodiment, the functions of the attack determining device 140 are implemented on devices (e.g., a device managing the replicating servers 150) already deployed in the contents delivery network.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Accordingly, the disclosure of the present invention is intended to be illustrative, but not limiting, of the scope of the present invention, which is set forth in the following claims.

What is claimed is:

1. A method of blocking an attack on an origin server, the method comprising:
monitoring traffic of the origin server in a network system;
making a first determination whether the monitored traffic is associated with the distributed denial-of-service (DDoS) attack; and
requesting a domain name system (DNS) in the network system to resolve a domain name associated with the origin server to at least one of a plurality of replicating servers storing data replicated from the origin server responsive to making the first determination that the monitored traffic is associated with the DDoS attack.

2. The method of claim 1, further comprising:
assessing an amount of the monitored traffic; and
determining that the monitored traffic is associated with the DDoS attack responsive to the amount of the monitored traffic exceeding a predetermined value.

3. The method of claim 1, further comprising
making a second determination whether the monitored traffic is suspected of being associated with the DDoS attack; and
requesting the DNS to temporarily resolve the domain name associated with the origin server to the at least one of the plurality of replicating servers responsive to making the second determination that the monitored traffic is suspected of being associated with the DDoS attack, the request to temporarily resolve the domain name made prior to making the first determination.

4. The method of claim 1, wherein the DNS changes entries in a reference table or a database for matching the domain name of the origin server to an IP address responsive to receiving the request, the matching IP address in the reference table or the database changed from an IP address of the origin server to an IP address of the at least one of the plurality of replicating servers.

5. The method of claim 1, further comprising providing IP addresses of the plurality of replicating servers to a load balancer that is configured to select the at least one of the plurality of replicating servers to service requests to the origin server based on load conditions of the plurality of replicating servers.

6. The method of claim 1, further comprising requesting the origin server to provide contents to the plurality of replicating servers responsive to the final determination that the monitored traffic is associated with the DDoS attack.

7. The method of claim 1, further comprising blocking service requests to the origin server responsive to making the first determination that the monitored traffic of the origin server is associated with the DDoS attack.

8. The method of claim 1, further comprising requesting the DNS to resolve the domain name to the origin server responsive to determining that the DDoS attack is blocked or terminated.

9. An apparatus for blocking an attack on an origin server, the apparatus comprising:
a monitoring unit configured to monitor traffic of the origin server in a network system;
an attack determining unit configured to make a first determination whether the monitored traffic is associated with a distributed denial-of-service (DDoS) attack; and
an IP address changing unit configured to request a domain name system (DNS) in the network system to resolve a domain name associated with the origin server to at least one of a plurality of replicating servers storing data replicated from the origin server responsive to making the first determination that the monitored traffic is associated with the DDoS attack at the attack determining unit.

10. The apparatus of claim 9, wherein the monitoring unit is configured to:
assess an amount of the monitored traffic; and
determine that the monitored traffic is associated with the DDoS attack responsive to the amount of the monitored traffic exceeding a predetermined value.

11. The apparatus of claim 9, wherein the attack determining unit is configured to make a second determination whether the monitored traffic is suspected of being associated with the DDoS attack, and the IP address changing unit is further configured to request the DNS to temporarily resolve the domain name associated with the origin server to the at least one of the plurality of replicating servers responsive to making the second determination that the monitored traffic is suspected of being associated with the DDoS attack, the request to temporarily resolve the domain name made prior to making the first determination.

12. The apparatus of claim 9, wherein the DNS changes entries in a reference table or the database for matching the domain name of the origin server to an IP address responsive to receiving the request, the matching IP address in the reference table or the database changed from an IP address of the origin server to an IP address of the at least one of the plurality of replicating servers.

13. The apparatus of claim 9, further comprising an attack blocking unit configured to block service requests to the origin server responsive to making the first determination that the monitored traffic is associated with the DDoS attack.

14. The apparatus of claim 9, wherein the attack determining unit is configured to provide IP addresses of the plurality of replicating servers to a load balancer that is configured to select the at least one of the plurality of replicating servers to service requests to the origin server based on load conditions of the plurality of replicating servers.

15. The apparatus of claim 9, wherein the origin server provides contents to the plurality of replicating servers responsive to the final determination that the monitored traffic is associated with the DDoS attack.

16. The apparatus of claim 9, where in the IP address changing unit is further configured to request the DNS to resolve the domain name to the origin server responsive to determining that the DDoS attack is blocked or terminated.

17. A computer readable storage medium configured to store instructions thereon, the instructions when executed by a processor in an attack determining device, cause the attack determining device to:
monitor traffic of an origin server in a network system;
make a first determination whether the monitored traffic is associated with the distributed denial-of-service (DDoS) attack; and
request a domain name system (DNS) in the network system to resolve a domain name associated with the origin server to at least one of a plurality of replicating servers storing data replicated from the origin server responsive to making the first determination that the monitored traffic is associated with the DDoS attack.

18. The computer readable storage medium of claim 17, further comprising instructions to:
assess an amount of the monitored traffic; and
determine that the monitored traffic is associated with the DDoS attack responsive to the amount of the monitored traffic exceeding a predetermined value.

19. The computer readable storage medium of claim 17, further comprising instructions to:
make a second determination whether the monitored traffic is suspected of being associated with the DDoS attack; and
request the DNS to temporarily resolve the domain name associated with the origin server to the at least one of the plurality of replicating servers responsive to making the second determination that the monitored traffic is suspected of being associated with the DDoS attack, the request to temporarily resolve the domain name made prior to making the first determination.

20. The computer readable storage medium of claim 17, wherein the DNS changes entries in a reference table or a database for matching the domain name of the origin server to an IP address responsive to receiving the request, the matching IP address in the reference table or a database changed from an IP address of the origin server to an IP address of the at least one of the plurality of replicating servers.
